(19) United States
(12) Patent Application Publication
(10) Pub. No.: US 2007/0153037 A1
(43) Pub. Date: Jul. 5, 2007

(54) Printing device and method for controlling such a printing device

(75) Inventors: Rick Walraven, Eindhoven (NL); Ernst H.C. Ullersma, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/648,783

(22) Filed: Jan. 3, 2007

(30) Foreign Application Priority Data
Jan. 5, 2006 (EP) EP 06100021.2

(51) Int. Cl. B41J 29/38

(52) U.S. Cl. 347/9

(57) ABSTRACT

A printing device and method for printing the surface of a substrate with a printing ink wherein a primary printing component and a secondary printing component are heated to their respective surface temperatures through the cooperation of a controller.

This application claims the priority benefit of European Patent Application No. 06100021.2 filed Jan. 5, 2006, which is hereby incorporated by reference.

### BACKGROUND OF THE INVENTION

The present invention relates to a printing device and a method for controlling a printing device.

Many different types of printing devices have been invented, a large number of which are presently in use. The known forms of printing devices have a variety of methods for marking the print media with a relevant marking material (e.g., toner, ink etc.). Commonly used forms of printing include offset printing, laser printing and copying devices, dot matrix type impact printers, thermal paper printers, film recorders, thermal wax printers, dye sublimation printers and inkjet printers both of the drop on demand and continuous flow type.

In general, a printing device comprises one or more primary printing means that is essentially needed for performing a printing job. These are the means that come into actual contact with the marking material and are principally needed to perform the printing process. Usually a printer also comprises a secondary printing means for supporting the primary printing means, such as marking material delivery units, cleaners, sensors etc. The primary printing means are usually heated to a constant temperature so as to enable a normal printing job to be achieved, such as e.g., transferring and fixing a toner image formed on a photosensitive medium onto a sheet of paper. Therefore, in order to make sure that the printing device is ready to perform a print job, at least the primary printing means are adequately heated. During a typical start-up of the known printing device, the printing device is gradually heated up until a heat-up completion temperature is achieved. More particularly, the printing device is heated up before a first printing is performed, and is further heated up while performing the first printing job and during one or more subsequent printing jobs until the printing device achieves a final (more or less equilibrium) state. A major drawback of this method for controlling the printing device is that the circumstances, such as the temperature of the primary and secondary printing means, before performing a printing job are commonly dependent on the number of printing jobs and the length of the printing jobs already performed. In particular in the situation when relatively small printing jobs are to be performed, and wherein relatively lengthy intervals are present between the printing jobs (during which intervals the mass of the printing means cools off since the printer is then kept in a stand-by or even sleep-mode), the circumstances before the respective printing jobs commonly diverse significantly. A substantial difference of the circumstances before each printing job will result in a (significant) difference of print quality between toner images generated during different (subsequent) printing jobs. The print quality may thereby be determined amongst others by gloss, streak invariability, and default invariability of the toner images.

### SUMMARY OF THE INVENTION

It is an object of the present invention to provide an improved method for controlling a printer, wherein images with a relatively constant print quality can be generated.

This object can be achieved by generating a method comprising the steps of: A) heating up primary printing means of the printing device such that at least a surface area of this means has a temperature suitable to perform a first printing job, B) performing said first printing job, and C) heating the mass of the primary printing means substantially to it's surface temperature before a subsequent printing job is performed. By heating up the mass of the primary printing means thoroughly the circumstances can be held substantially similarly, which will result in a predetermined and relatively constant print quality of the images generated during the subsequent printing jobs. Gradually, substantially heating up the printing device during the respective printing jobs can be counteracted in this manner, and the recovery time after each printing job can be reduced significantly. During step A) at least surface areas of the primary printing means are heated up until a temperature is reached at which the first printing job can be performed. A surface area in this respect means the area of the primary means that comes in contact with the marking material that is used to actually mark the receiving material (substrate), e.g., a piece of paper. During step C) the primary printing means is further heated, wherein not merely the surface areas of the primary printing means is heated up, but also the mass, i.e., deeper (core) areas of the primary printing means is heated up. As a result of this, the primary printing means is heated up substantially thoroughly. In this manner, a substantially homogeneous temperature of the primary printing means is obtained, thereby improving the constancy of the print quality of images of the printing device. The first printing job may be a regular printing job requested by a user. However, it is also conceivable that the first printing job is formed by a characteristic conditioning job typically performed by the printing device during an initialising process. Commonly, the printing device will be situated initially in a sleep mode or a power-off mode before the first printing job is performed.

In a preferred embodiment during step C) (and/or during step A) at least a part of the mass of the secondary printing means of the printing device is also heated up substantially to it's surface temperature. Again, it is noted that the primary printing means are adapted to perform a printing job, while the secondary printing means are adapted to support the primary printing means during and/or after performing the printing job. An example of a secondary printing means is formed by a slot cleaner to remove paper fibers, paper dust, and silica from slots and openings of the primary printing means. Heating up the primary printing means and at least a (substantial) part of the secondary printing means of the printing device may be continued until a heat-up completion temperature of the respective surface areas is achieved. This heat-up completion temperature may be similar to the (default) operating temperature of both the primary printing means and the secondary printing means. However, preferably, this heat-up completion temperature is set above said (default) operating temperature to allow a minor cool down of the primary printing means and the secondary printing means without forcing the primary printing means and the secondary printing means to operate below the (default) operating temperature. Besides equalizing the environmental circumstances for performing the respective printing jobs by initially substantially heating up the primary printing means and at least a (substantial) part of the secondary printing means of printing device substantially thoroughly, the method according to this embodiment involves also another major advantage. By initially heating up the secondary printing means, or at least a (substantial) part thereof, significantly and thoroughly, the reliability of the secondary printing means during operation can be improved substantially. In contrary to the method known from the prior art, the secondary printing means is no longer heated up gradually before and during multiple printing jobs, as a result of which the secondary printing means would operate at a relatively cold, and hence sensitive state. According to the improved method the secondary printing means are also heated up substantially before performing the first printing job, as a result of which, operation of this secondary printing means will merely occur in a heated-up state, wherein the degree of wear by friction can be reduced, and the reliability of the secondary printing means can be improved significantly.

It is emphasized that steps A)-C) of the method do not necessarily need to be performed in succession. For example, it is conceivable that the primary printing means is heated up substantially thoroughly during the performing of the first printing job, as a result of which step B) and step C) are performed simultaneously for at least a period of time. Besides, it is also conceivable for a person skilled in the art to initially heat up the primary printing means substantially thoroughly, before performing the first printing job, thereby integrating step C) with step A).

Preferably, the method further comprises step D) comprising performing at least one subsequent printing job after step C) has been completed. Due to the particular initial heat-up of the primary printing means, and preferably of the secondary printing means, the environmental circumstances before performing each printing job will be more or less similar. However, it may be preferred that the method further comprises step E) comprising heating up the primary printing means after a subsequent printing job has been performed, and preferably before eventual one or more remaining printing jobs are performed. In this manner a (single) supplementary heat-up of the primary printing means, and more preferably of the secondary printing means can be realized, which is, e.g., favorable in the case where the primary printing means has cooled down to a temperature below the operation temperature. In an alternative embodiment heating up the primary printing means (step E) is realized while performing the at least one subsequent printing jobs, at least for a period of time.

In a preferred embodiment the method according to the present invention further comprises step F) which includes allowing the printing device to (passively) cool down after completion of the at least one printing job. In this manner, commonly unnecessary power consumption by the printing device can be prevented.

The present invention also relates to a printing device, comprising: primary printing means for performing a printing job, and a controller for performing the method according to the invention. Advantages of this printing device, and in particular of the method for controlling such a printing device have already been described above in a comprehensive manner. In a preferred embodiment the printing device further comprises secondary printing means for supporting the primary printing means. In another preferred embodiment the printing device comprises thermal insulation means for thermally insulating the primary printing means and/or the secondary printing means. In this way heat emission towards the atmosphere surrounding the printing device can be prevented, or at least counteracted, as a result of which the primary printing means and/or the secondary printing means can be held on temperature relatively long-lastingly.

### BRIEF DESCRIPTION OF THE DRAWINGS

The present invention will be illustrated by means of the following non-limitative embodiment, wherein:

FIG. 1 shows a perspective view of a printer according to the present invention.

### DETAILED DESCRIPTION OF THE INVENTION

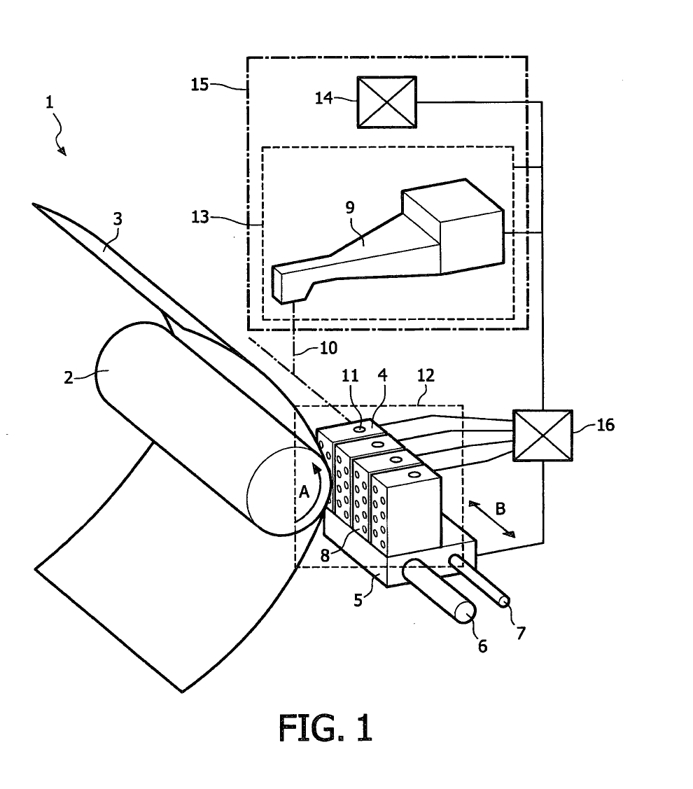

FIG. 1 shows a perspective view of an ink jet printer 1 according to the present invention. In this embodiment the printer 1 comprises a roller 2 for supporting a substrate 3 for moving it along the four printheads 4. The roller 2 is rotatable about its axis as indicated by arrow A. A carriage 5 carries the four printheads 4 and can be moved in reciprocation in the direction indicated by the double arrow B, parallel to roller 2. In this way the printheads 4 can scan the receiving substrate 3, for example a sheet of paper. The carriage 5 is guided over rods 6 and 7 and is driven by means suitable for the desired purpose (not shown). In the embodiment shown in this Figure, each printhead 4 contains eight ink ducts, each with its own nozzle 8, which form two rows of four nozzles each perpendicular to the axis of the roller 2. In a practical embodiment of the printer, the number of ink ducts per printhead 4 will be many times greater. Each ink duct is provided with means for energizing the ink duct (not shown) and an associated electric actuation circuit (not shown). In this way, the ink duct, the means for energizing the ink duct, and the actuation circuit all form a unit which can serve to eject ink drops in the direction of roller 2. If the ink ducts are energized image-wise, an image is formed which is built up from ink drops on the substrate 3. When a substrate is printed with a printer of this kind in which ink drops are ejected from ink ducts, the substrate, or part thereof, is (imaginarily) divided into fixed locations which form a regular field of pixel rows and pixel columns. In one embodiment, the pixel rows are perpendicular to the pixel columns. The resulting separate locations can each be provided with one or more ink drops. The number of locations per unit of length in the directions parallel to the pixel rows and pixel columns is termed the resolution of the printed image, and is indicated, for example, as 400×600 d.p.i. (“dots per inch”). By the image-wise energization of a row of nozzles of the printhead 4 of the printer when it moves over a strip of the substrate 3 in a direction substantially parallel to the pixel rows, the row of nozzles being substantially parallel to the pixel columns, as shown in the Figure, an image is built up from ink drops formed on the substrate 3. In this embodiment, the printer 1 is provided with a number of dispensing devices 9, one for each color, only one being shown in this figure for simplification. With a dispensing device of this kind, it is possible to dispense ink pellets at each of the printheads 4. The ink used in this non-limitative embodiment is a hot melt ink. An ink of this kind is solid at room temperature and liquid at elevated temperature. The ink is dispensed in solid form in each of the printheads, whereafter the ink in the printhead is melted and is brought to operating temperature, typically 130° Celsius. As soon as there is a shortage of liquid ink in one of the printheads, the carriage 5 will be moved so that the relevant printhead is disposed beneath the corresponding dispensing device, level with dispensing line 10. One or more ink pellets will then be dispensed to the printhead 4, said pellets entering the printhead 4 via opening 11. These pellets are then melted and brought to operating temperature. In this way each printhead 4 can be provided with sufficient ink at all times. The printheads 4 are the primary printing components 12 (schematically shown), said primary printing components 12 being essentially needed to perform printing jobs. These primary printing components 12 are supported by the dispensing device 9, which in this case is the secondary printing component 13, (schematically shown) to facilitate and support printing jobs to be performed. The printer 1 further comprises a heating element 14 to heat up both the primary printing components 12 and the secondary printing components 13 until the operation temperature of these components 12, 13 is achieved. The primary printing component 12, the secondary printing component 13, and the heating element 14 are surrounded by an insulation layer 15 to avoid, or at least counteract, heat emission towards the atmosphere surrounding the printer 1. The printer 1 also comprises a controller 16 adapted to control at least the primary printing components 12 and the secondary printing components 13, and moreover the heating element 14 to (initially) substantially, thoroughly heat up the primary printing components 12 and, preferably the secondary printing components 13, during a (defined) first printing job being performed. In this manner the initial circumstances before each following printing job can be held substantially similar, since no (additional) substantial heating up of the primary printing components 12, and preferably of the secondary printing components 13, between subsequent printing jobs is commonly required. Optionally, the primary printing components 12 and the secondary printing components 13 may be (preferably once-only) additionally heated after completion of the first printing job to ensure a sufficient heat-up of these critical components 12, 13.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for controlling a printing device, which comprises the steps of:
A) heating up a primary printing component of the printing device such that at least the surface area of this component has a temperature suitable to perform a first printing job,
B) performing said first printing job, and
C) heating the mass of the primary printing component substantially to it's surface temperature before a subsequent printing job is performed.

2. The method according to claim 1, wherein during step C) at least a part of the mass of a secondary printing component of the printing device is also heated up substantially to it's respective surface area temperature.

3. The method according to claim 2, wherein during step C) the substantially entire mass of the secondary printing component is heated up substantially to it's surface area temperature.

4. The method according to claim 1, wherein step B) and step C) are performed simultaneously for at least a period of time.

5. The method according to claim 1, wherein step A) and step C) are performed simultaneously for at least a period of time.

6. The method according to claim 1 further comprising step D) of performing at least one subsequent printing job after step C) has been completed.

7. The method according to claim 6, which further comprises step E) of heating up the printing device after a subsequent printing job has been performed.

8. The method according to claim 7, which further comprises step F) of allowing the printing device to cool down after completion of all printing jobs.

9. A printing device, comprising:
a primary printing component for performing a printing job, and
a controller for performing the method as claimed in claim 1.

10. The printing device according to claim 9, further comprising a secondary printing component for supporting the primary printing component.

11. The printing device according to claim 10, wherein the printing device further comprises thermal insulation for thermally insulating the primary printing component and/or the secondary printing component.

12. A printing device which comprises:
a roller rotatable about its axes, said roller adapted to support a substrate,
a primary printer component operatively associated with said roller for scanning said substrate,
a secondary printing component operatively communicating with the primary printing component for dispensing ink pellets to the primary printing component,
heating means for heating the primary printing component and the secondary printing component, and
controller means for controlling the primary printing component, the secondary printing component and the heating means.

13. The printing device of claim 1, wherein the primary printing component comprises a plurality of printheads.

14. The printing device of claim 1, wherein the primary printer component, the secondary printing component and the heating means are provided with an insulation means.
